(19) United States
(12) Patent Application Publication
(10) Pub. No.: US 2008/0080188 A1
(43) Pub. Date: Apr. 3, 2008

(54) Modulized Assembly Of A Large-sized LED Lamp

(76) Inventor: Chin-Wen Wang, Pingzhen City (TW)

Correspondence Address: HDSL, 4331 STEVENS BATTLE LANE, FAIRFAX, VA, 22033, US

(21) Appl. No.: 11/537,546

(22) Filed: Sep. 29, 2006

(51) Int. Cl. G03B 15/02

(52) U.S. Cl. 362/294; 362/17

(57) ABSTRACT

A modulized assembly for a large-sized LED lamp includes a shell, a cover, a light-transmitting mirror and a plurality of LED modules. The interior of the shell is formed with a separation plate. The separation plate is provided with a plurality of through troughs thereon. The cover is covered and connected above the shell, and formed with venting troughs in communication with the outside air thereon. Further, the light-transmitting mirror is sealed and connected to the underside of the shell. The LED module includes a plate body and a LED lamp set connected to the plate body. The plate body is correspondingly sealed and connected to individual trough troughs of the separation plate. Among the shell, the light-transmitting mirror and the plate body, a sealed space is enclosed. The LED lamp set is accommodated in the sealed space and illuminates toward the light-transmitting mirror. With the above arrangement, the assembling process between each LED module and the associated shell becomes much easier. Further, it is also much easier and more convenient to repair each damaged LED module.

### BACKGROUND OF THE INVENTION

1. Field of the Invention

The present invention relates to a modulized assembly of a large-sized LED lamp, and in particular to a modulized assembly of a large-sized LED lamp, whereby it is much easier to assemble each LED module with a shell.

2. Description of Prior Art

Since light-emitting diodes (LED) have many advantages, such as high-intensity, electricity-saved and long-life, they are widely used in illumination devices. A plurality of LED lamps is usually arranged and connected on a circuit board and thus forms a LED lamp set. Then, a plurality of LED lamp sets is arranged in series or in parallel to form a LED lamp. In this way, a large range of illumination and the requirement for high intensity can be achieved. Further, the LED lamp can be used for an indoor or outdoor illumination device.

A conventional structure of a LED lamp disclosed in Taiwan Utility Model Patent Publication No. M292042 includes an upper cover, a light-transmitting mirror, a separation plate, a LED lamp set, a heat pipe and a heat-dissipating piece set. The upper cover is provided with a venting trough. The light-transmitting mirror is connected to the upper cover. The separation plate is horizontally connected between the upper cover and the light-transmitting mirror to define a first and second space. The center of the separation plate is provided with an opening. The LED lamp set comprises a circuit board and a plurality of LED lamps fixedly connected on the bottom surface of the circuit board. The top surface of the circuit board is brought into contact with an end of the heat pipe. The circuit board is sealed in an opening of the separation plate with each LED lamp accommodated in the second space and the heat pipe and the heat dissipator accommodated in the first space. The heat dissipator is connected to the other end of the heat pipe. With the above arrangement, a LED lamp can be formed.

However, in practice, the conventional LED lamp still has some drawbacks as follows. Since the plurality of LED lamps is welded on the circuit board in a large area, each LED lamp is located at different positions and thus generates different working temperatures. The working temperature will directly affect the life of the LED lamp. After being used for a period of time, the LED lamps will be inevitably damaged. If the number of the damaged LED lamps is too large, the illumination of the light will be insufficient, and thus it is necessary to carry out detaching and repairing operations. During the detachment, the welds of each damaged LED lamp should be removed first, and then performs a welding operation again, which not only causes the complexity and inconvenience of the repairing operation, but also waste a great amount of labor and cost. Therefore, the practicability and economical effect thereof will be substantially reduced. Further, if only the heat pipe is used for heat conduction, the surface area directly contacting with the LED lamp sets is very limited, and thus the heat dissipated by the heat pipe is also limited. Especially, as the gradual development of high-power LED lamps, the above structure cannot satisfy the requirement for a large-sized LED lamp in current stage. Moreover, since the above structure does not has a temperature sensor for sensing the temperature of the LED lamp, after the working temperature of each LED lamp rises, the life of the internal LED lamps will be substantially reduced because there is no protective mechanism to perform a suitable protection measure.

### SUMMARY OF THE INVENTION

The object of the present invention is to provide a modulized assembly for a large-sized LED lamp. With individual arrangement of each LED modules, the assembling process between each LED lamp module and the associated shell becomes much easier. Further, the repair of each damaged LED module is also much easier and more convenient.

The present invention provides a modulized assembly for a large-sized LED lamp, which includes a shell, a cover, a light-transmitting mirror and a plurality of LED modules. The interior of the shell is formed with a separation plate. The separation plate is provided with a plurality of through troughs thereon. The cover is covered and connected above the shell, and formed with venting troughs in communication with the outside air. Further, the light-transmitting mirror is sealed and connected below the shell. The LED module comprises a plate body and a LED lamp set connected to the plate body. The plate body is sealed and connected correspondingly to the individual through troughs of the separation plate. Among the shell, the light-transmitting mirror and the plate body, a sealed space is enclosed. The LED lamp set is accommodated in the sealed space and illuminates toward the light-transmitting mirror.

### BRIEF DESCRIPTION OF THE DRAWINGS

FIG. 1 is an exploded perspective view of the shell and the LED module of the present invention;

FIG. 2 is an exploded perspective view of the LED module of the present invention;

FIG. 3 is an assembled view of the shell and the LED module of the present invention;

FIG. 4 is an exploded perspective view of the present invention;

FIG. 5 is an assembled view of the present invention; and

FIG. 6 is an assembled cross-sectional view of the present invention.

### DETAILED DESCRIPTION OF THE INVENTION

The detailed description and the technical contents of the present invention will be made with reference to the accompanying drawings. However, it should be understood that the drawings are illustrative but not used to limit the scope of the present invention.

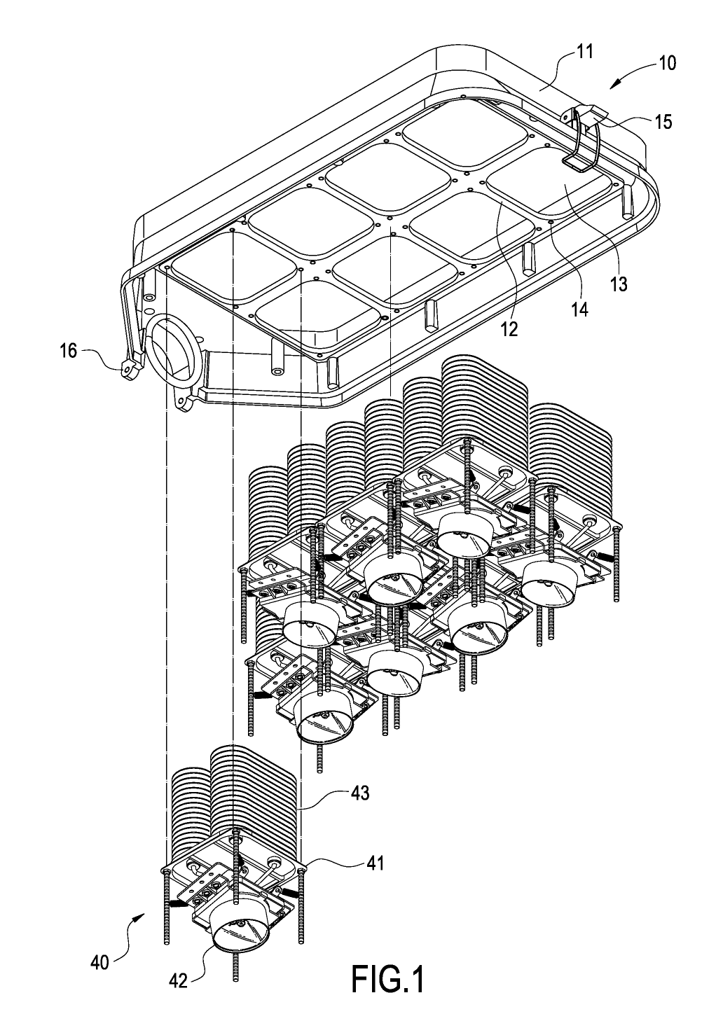

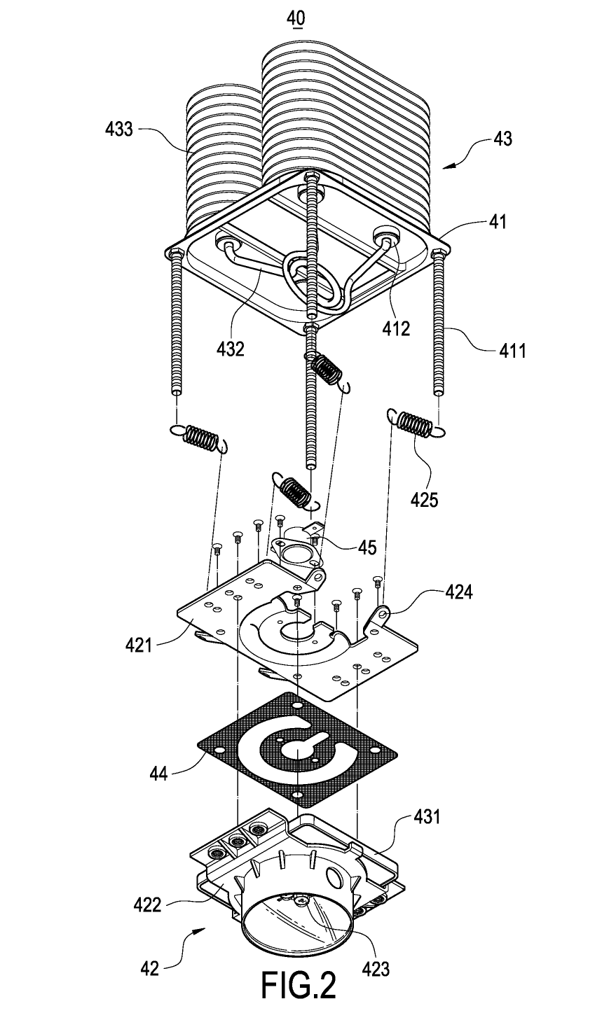

FIG. 1 is an exploded perspective view of the shell and the LED module of the present invention. FIG. 2 is an exploded perspective view of the LED module of the present invention.

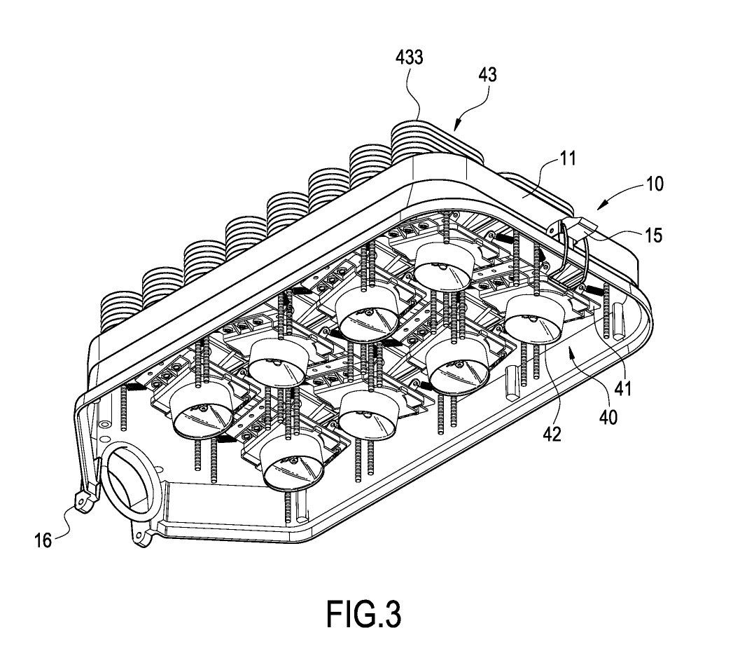

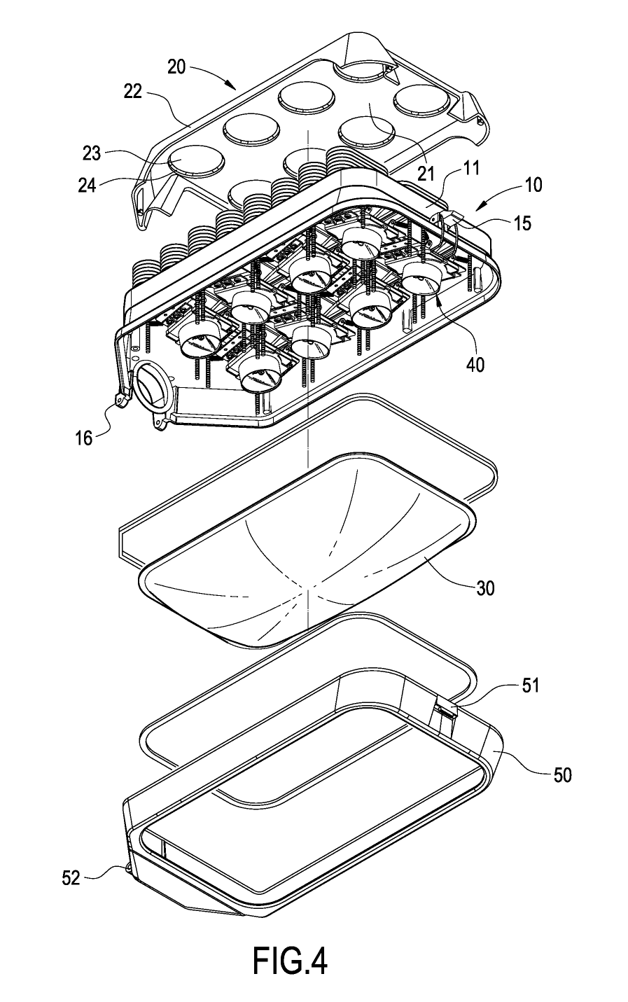

FIG. 3 is an assembled view of the shell and the LED module of the present invention. The present invention provides a modulized assembly for a large-sized LED lamp, which comprises a shell 10, a cover 20 (FIG. 4), a light-transmitting mirror 30 (FIG. 4) and a plurality of LED modules 40.

The shell 10 has a substantially rectangular frame 11. The middle portion within the frame 11 is formed with a horizontal separation plate 12. The separation plate 12 is provided with a plurality of rectangular through troughs 13 thereon. The four corners of the through trough are provided with screw holes 14, respectively. The front and rear of the outside of the frame 11 are provided with a trigger 15 and a shaft seat 16.

With reference to FIG. 4, the cover 20 is constituted of a top plate 21 and peripheral plates 22 bending downwardly from the periphery of the top plate 21. The top plate 21 has a plurality of cap 23 protruding from the top plate 21. The gap between each cap 23 and the top plate 21 is formed with a venting trough 24 in communication with the outside air.

As shown in FIG. 4, the light-transmitting mirror 30 can be made of a transparent or translucent material and directly connected to the underside of the frame 11 of the shell 10. The present embodiment further includes a substantially rectangular lower frame 50 (FIG. 4). The lower frame 50 can be connected to the light-transmitting mirror 30 and then connected with the shell 10. The front side thereof is provided with a hook 51 to correspond to the trigger 14, and the rear side thereof is provided with another shaft seat 52 to correspond to the shaft seat 16 for connecting with a pivot (not shown).

The LED module 40 comprises a plate body 41, a LED lamp set 42 and a heat dissipator 43. The plate body 41 is formed into a rectangular shape and connected with bolts 411 at four corners. The middle of the plate body is provided with a plurality of through holes 412. The LED lamp set 42 comprises a fixing seat 421, a lamp cover 422 connected to the underside of the fixing seat 421, and a plurality of LED lamps 423 accommodated in the lamp cover 422. The fixing seat 421 is provided with a plurality of hanging holes 424 thereon. Both ends of a tension spring 425 are hooked to the hanging hole and the bolt 411 and thus positioned in place.

The heat dissipator 43 comprises an isothermal plate 431, a plurality of heat pipes 432 and a plurality of heat-dissipating piece sets 434. The isothermal plate 431 is fixedly connected above the lamp cover 422, and contacts with the back surface of each LED lamp 423. Each heat pipe 432 has annular to-be-heated ends and upright heat-releasing ends. The to-be-heated end is sandwiched between the fixing seat 421 and the isothermal plate 431. The to-be-heated end extends upwardly to penetrate the through hole 412 of the plate body 41, and is connected with each heat-dissipating piece set 434. With a large surface contact between the isothermal plate 431 of the heat dissipator 43 and the LED lamp set 42, the heat pipe 432 can be used to dissipate heat along a long distance. In this way, the whole efficiency in heat conduction and heat dissipation can be substantially improved so as to prolong the life of the LED lamp 423.

Further, the LED module 40 comprises a soft gasket 44 and a temperature sensor 45. The soft gasket 44 is sandwiched between the corresponding end faces of the fixing seat 421 and the isothermal plate 431, thereby to make the contacting effect more uniform and balanced between the isothermal plate 431 and the to-be-heated end of the heat pipe 432. The temperature sensor 45 is fixedly connected on the fixing seat 421 and contacts with the isothermal plate 431 so as to sense the temperature of the isothermal plate 431. When the working temperature of the LED lamp 423 rises to higher than a preset value, the power supplied to the LED lamp set 42 is immediately shut off to cool and reduce the temperature of the LED lamp set 42. On the other hand, when the temperature reduces to a preset value for activation, the power can be automatically supplied again so that the LED lamp 423 of the LED lamp set 42 can illuminate. In this way, the LED lamp set 42 can be protected.

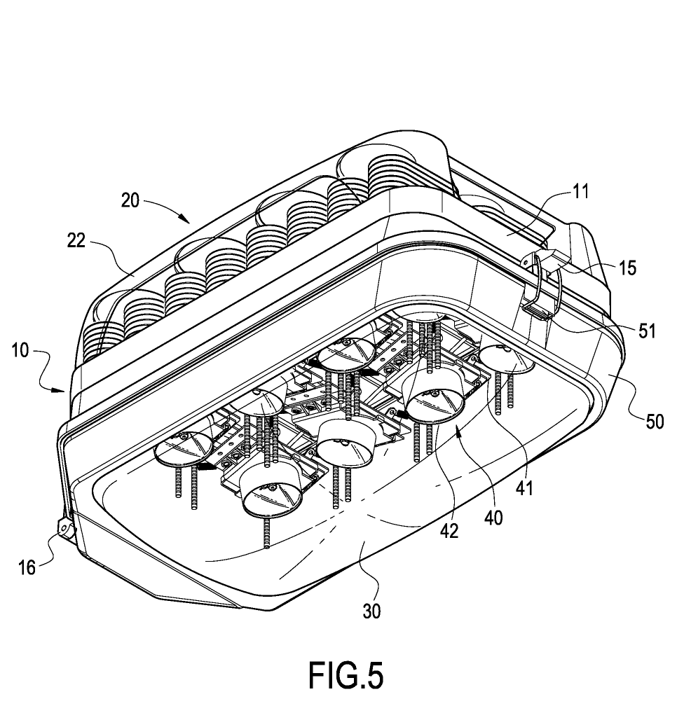

FIGS. 4, 5 and 6 are an exploded perspective view, assembled view and an assembled cross-sectional view of the present invention. In assembling, each LED module 40 is mounted on the separation plate 12 of the shell 10, respectively. The heat-dissipating piece set 433 and the LED lamp set 42 are formed on upper and lower sides of the separation plate 12, respectively. Then, the cover 20 is covered and connected above the shell 10, and the light-transmitting mirror 30 is disposed into the lower frame 50 and connected thereto. The contacting portion between the light-transmitting mirror 30 and the lower frame 50 is provided with waterproof tapes. Finally, the lower frame 50 is correspondingly covered to the shell with the pivot penetrating into the shaft seats 16, 52 in the back and connected thereto. The trigger 15 is fastened with the hook 51 in the front. Since each LED module 40 is separately arranged, it is much easier to assemble each LED module with the shell 10. When each LED module 40 is damaged, it is only necessary to detach and replace the damaged LED module, thereby substantially simplify the time and process of repair.

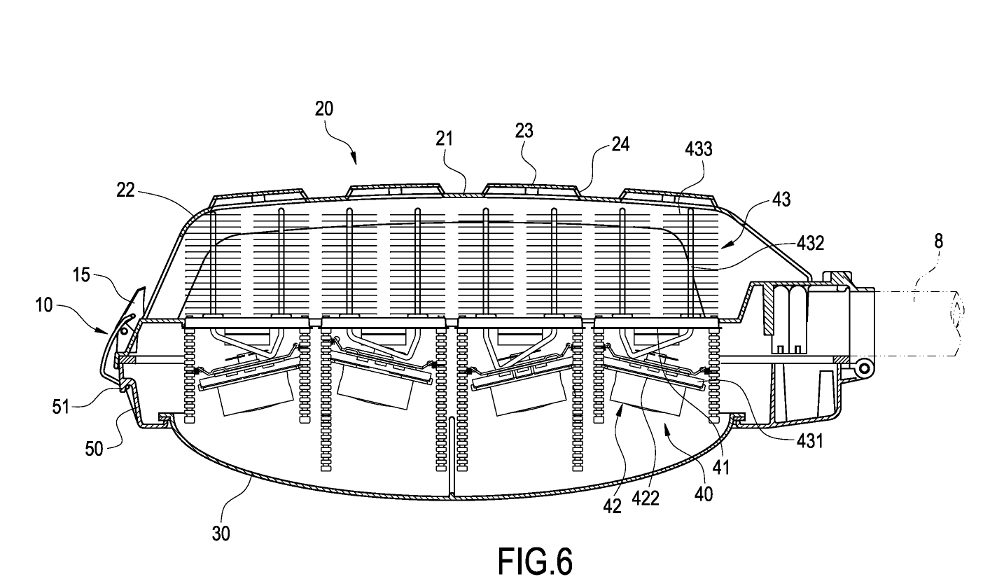

In use, the LED lamp can be connected to a distal end of a lamp rod 8 (FIG. 6). A current is applied to the LED lamp set 42, so that each LED lamp 423 can illuminate and generate heat. With the large surface contact of the isothermal plate 431 and a heat-conducting mechanism between liquid and vapor phases, the thus-generated heat can be rapidly dissipated to the top surface of the isothermal plate 431, and then conducts to the to-be-heated end of the heat pipe 432. Then, the heat is conducted from the to-be-heated end to the heat-releasing end. With the contacting effect between the heat-releasing end and the heat-dissipating piece set 433, the heat can be dissipated from each heat-dissipating piece. In addition, the venting trough 24 of the cover 20 is in communication with the outside air, thereby to produce a thermal convection between the inside air and the outside air. In this way, the heat of each heat-dissipating piece can be dissipated to the outside of the cover 20, so that each LED lamp 423 illuminates at a lower temperature to prolong its life.

According to the above, the present invention indeed has industrial applicability, novelty and inventive steps. Further, the present invention has not been published or used in public prior to filing for a patent and thus conforms to the requirements for a utility model patent.

Although the present invention has been described with reference to the foregoing preferred embodiments, it will be understood that the invention is not limited to the details thereof Various equivalent variations and modifications can still be occurred to those skilled in this art in view of the teachings of the present invention. Thus, all such variations and equivalent modifications are also embraced within the scope of the invention as defined in the appended claims.

What is claimed is:

1. A modulized assembly of a large-sized LED lamp, comprising:
a shell formed with a separation plate therein, the separation plate provided with a plurality of through troughs thereon;
a cover covered and connected above the shell, the cover formed with venting troughs in communication with the outside air;
a light-transmitting mirror sealed and connected to the underside of the shell and;
a plurality of LED modules comprising a plate body and a LED lamp set connected to the underside thereof,
wherein the plate body is correspondingly sealed and connected to the through trough of the separation plate, a sealed space is formed among the shell, the light-transmitting mirror and the plate body, the LED lamp set is accommodated within the sealed space and illuminates toward the light-transmitting mirror.

2. The modulized assembly of a large-sized LED lamp according to claim 1, wherein the shell has a frame, and the middle of the interior of the frame is formed with the separation plate.

3. The modulized assembly of a large-sized LED lamp according to claim 1, wherein the cover is constituted of a top plate and peripheral plates bending downwardly from the periphery of the top plate, the top plate is provided with a plurality of caps protruding from the top plate, and a gap between the cap and top plate is formed with the venting trough.

4. The modulized assembly of a large-sized LED lamp according to claim 1, wherein four corners of the plate body of the LED module is connected with bolts, and the LED lamp set comprises a fixing seat and a lamp cover connected to the fixing seat, the fixing seat is provided with a plurality of hanging holes thereon, and a tension spring is connected between each hanging hole and the bolt.

5. The modulized assembly of a large-sized LED lamp according to claim 4, wherein the LED module further comprises a heat dissipator, the heat dissipator comprises an isothermal plate, a plurality of heat pipes and a plurality of heat-dissipating piece sets, the isothermal plate is fixedly connected above the lamp cover, one end of each heat pipe is sandwiched between the fixing seat and the isothermal plate, and the other end thereof penetrates the plate body and connected to each heat-dissipating piece set.

6. The modulized assembly of a large-sized LED lamp according to claim 5, wherein the LED module further comprises a soft gasket sandwiched between the corresponding end faces of the fixing seat and the isothermal plate.

7. The modulized assembly of a large-sized LED lamp according to claim 6, wherein the LED module further comprises a temperature sensor fixedly connected on the fixing seat and contacting with the isothermal plate so as to sense the temperature of the isothermal plate.

8. The modulized assembly of a large-sized LED lamp according to claim 1, further comprising a lower frame, the lower frame connected to the underside of the shell after being connected with the light-transmitting mirror.
